(19) United States
(12) Patent Application Publication
(10) Pub. No.: US 2026/0195851 A1
(43) Pub. Date: Jul. 9, 2026

(54) REMOTE OPERATION SYSTEM

(71) Applicant: TOYOTA JIDOSHA KABUSHIKI KAISHA, Toyota-shi (JP)

(72) Inventors: Takahiro ITO, Tokyo (JP); Rio SUDA, Toyota-shi (JP)

(73) Assignee: TOYOTA JIDOSHA KABUSHIKI KAISHA, Toyota-shi (JP)

(21) Appl. No.: 19/410,336

(22) Filed: Dec. 5, 2025

(30) Foreign Application Priority Data
Jan. 6, 2025 (JP) 2025-001770

(51) Int. Cl. G06T 3/4038; H04N 7/18

(52) U.S. Cl. CPC G06T 3/4038; H04N 7/181

(57) ABSTRACT

A remote operation system acquires an image set including images obtained by using one or more cameras mounted on a moving object. The system executes image adjustment processing of acquiring an adjusted image set by adjusting at least one image, and displays the adjusted image set on a remote operator terminal. A first plane is orthogonal to an optical axis of a camera corresponding to the first image. A second plane is orthogonal to an optical axis of a camera corresponding to the second image. In the image adjustment processing, the first image is disposed on the first plane and the second image is disposed on the second plane. In the image adjustment processing, the adjusted image set is acquired by viewing the first image and the second image that are disposed, from a common viewpoint, and by projecting the first image and the second image onto a common plane.

### CROSS-REFERENCE TO RELATED APPLICATION

This application claims priority to Japanese Patent Application No. 2025-001770 filed on Jan. 6, 2025. The disclosure of the above-identified application, including the specification, drawings, and claims, is incorporated by reference herein in its entirety.

### BACKGROUND

### 1. Technical Field

The present disclosure relates to a remote operation of a moving object by a remote operator.

### 2. Description of Related Art

Japanese Unexamined Patent Application Publication No. 2021-067977 (JP 2021-067977 A) discloses a technique of stitching a plurality of images captured by a plurality of cameras to expand a field of view.

### SUMMARY

A remote operation of a moving object by a remote operator is considered. An image (video) captured by a camera mounted on the moving object is presented to the remote operator. Here, in order to expand the field of view, presentation of a plurality of images obtained by one or more cameras (a plurality of cameras or a fisheye camera) mounted on the moving object to the remote operator is considered. For example, the presentation of the images to the remote operator by arranging the images adjacent to each other is considered. However, since imaging directions of the images are different from each other, simply arranging the images adjacent to each other may cause discomfort at an inter-image boundary. For example, a line such as a white line on a road surface may appear unnaturally bent at the inter-image boundary.

One object of the present disclosure is to provide a technology for suppressing discomfort in a case where a plurality of images obtained by one or more cameras (a plurality of cameras or a fisheye camera) mounted on a moving object are presented to a remote operator.

One viewpoint of the present disclosure relates to a remote operation system for a remote operation of a moving object by a remote operator. The remote operation system includes one or more processors.

The one or more processors acquire an image set including a plurality of images obtained by using one or more cameras mounted on the moving object. The one or more processors execute image adjustment processing of acquiring an adjusted image set by adjusting at least one of the images. The one or more processors display the adjusted image set on a remote operator terminal used by the remote operator.
The images include a first image and a second image. A first plane is a plane orthogonal to an optical axis of a camera corresponding to the first image. A second plane is a plane orthogonal to an optical axis of a camera corresponding to the second image. In the image adjustment processing, the first image is disposed on the first plane and the second image is disposed on the second plane. Further, in the image adjustment processing, the adjusted image set is acquired by viewing the first image and the second image that are disposed, from a common viewpoint, and by projecting the first image and the second image onto a common plane.

According to the present disclosure, the image adjustment processing is executed on an image set obtained by using one or more cameras mounted on the moving object. In the image adjustment processing, the first image is disposed on the first plane and the second image is disposed on the second plane. Further, in the image adjustment processing, the adjusted image set is acquired by viewing the first image and the second image that are disposed, from a common viewpoint, and by projecting the first image and the second image onto a common plane. Then, the adjusted image set is displayed on the remote operator terminal. Through such image adjustment processing, for example, bending of a line such as a white line at an inter-image boundary is suppressed. That is, discomfort felt by the remote operator is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing the configuration example of the remote operation system and a specific example of image adjustment processing;

FIG. 2 is a conceptual diagram showing a plurality of cameras and the image adjustment processing;

FIG. 3A is a conceptual diagram showing an example of the image adjustment processing;

FIG. 3B is a conceptual diagram showing an example of the image adjustment processing;

FIG. 4A is a conceptual diagram showing an example of the image adjustment processing;

FIG. 4B is a conceptual diagram showing an example of the image adjustment processing;

FIG. 5 is a block diagram showing a functional configuration example related to the image adjustment processing; and

FIG. 6 is a block diagram showing a modification.

### DETAILED DESCRIPTION OF EMBODIMENTS

### 1. Outline of Remote Operation System

A remote operation (remote driving) of a moving object is considered. Examples of the moving object that is a target of the remote operation include a vehicle, a robot, and a flying object. The vehicle may be an autonomous driving vehicle or a vehicle driven by a driver. Examples of the robot include a logistics robot and a working robot. Examples of the flying object include a drone. As an example, a case where the moving object is a vehicle will be considered in the following description. In a case of generalization, the term “vehicle” in the following description is replaced with “moving object”.

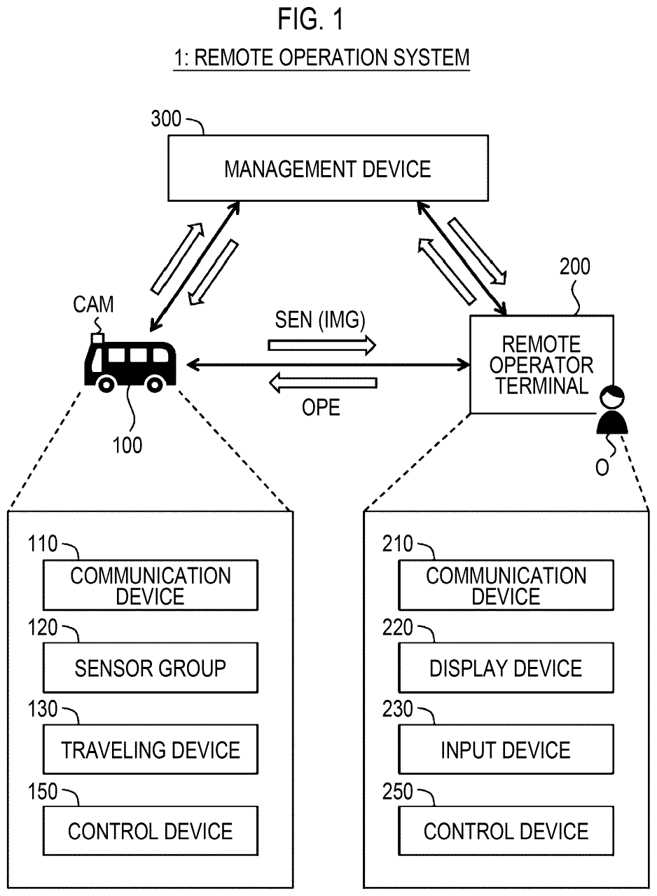

FIG. 1 is a schematic diagram showing a configuration example of a remote operation system 1 according to the present embodiment. The remote operation system 1 includes a vehicle 100, a remote operator terminal 200, and a management device 300. The vehicle 100 is a target of the remote operation. The remote operator terminal 200 is a terminal device used when a remote operator O performs the remote operation of the vehicle 100. The management device 300 performs management of the remote operation system 1. Typically, the management device 300 is a management server on a cloud. The management server may be configured of a plurality of servers that perform distributed processing.

The vehicle 100, the remote operator terminal 200, and the management device 300 can communicate with each other via a communication network. The vehicle 100 and the remote operator terminal 200 can communicate with each other via the management device 300. In addition, the vehicle 100 and the remote operator terminal 200 may communicate directly without going through the management device 300.

### 1-1. Configuration Example of Vehicle

The vehicle 100 includes a communication device 110, a sensor group 120, a traveling device 130, and a control device 150.

The communication device 110 communicates with the remote operator terminal 200 or the management device 300.

The sensor group 120 includes a recognition sensor, a vehicle state sensor, a position sensor, and the like. The recognition sensor recognizes (detects) a situation around the vehicle 100. Examples of the recognition sensor include a camera CAM, a LiDAR, and a radar. The camera CAM images the periphery of the vehicle 100 and acquires an image (video) IMG showing a situation around the vehicle 100. The vehicle state sensor detects a state of the vehicle 100. The vehicle state sensor includes a speed sensor, an acceleration sensor, a yaw rate sensor, a steering angle sensor, and the like. The position sensor detects a position and a heading of the vehicle 100. For example, the position sensor includes a GNSS sensor.

The traveling device 130 includes a steering device, a driving device, and a braking device. The steering device turns wheels. The steering device includes, for example, an electric power steering (EPS) device. The driving device is a power source that generates drive power. Examples of the driving device include an engine, an electric motor, and an in-wheel motor. The braking device generates a braking force.

The control device 150 is a computer that controls the vehicle 100. The control device 150 includes one or more processors, and one or more storage devices. The processor executes various types of processing. Examples of the processor include a CPU, a GPU, an ASIC, and an FPGA. The processor can also be referred to as circuitry or processing circuitry. The storage device stores various types of information. Examples of the storage device include a volatile memory, a non-volatile memory, an HDD, and an SSD. A function of the control device 150 may be implemented by cooperation between the processor that executes a control program and the storage device. The control program is stored in the storage device. The control program may be recorded in a computer-readable recording medium.

The control device 150 acquires sensor detection information SEN by using the sensor group 120. The sensor detection information SEN includes an image IMG, vehicle state information, position information, object information, and the like. The image IMG is captured by the camera CAM. The vehicle state information indicates a state (for example, speed, steering angle, and the like) of the vehicle 100 detected by the vehicle state sensor. The position information indicates a position and a heading of the vehicle 100 detected by the position sensor. The object information is information related to objects (for example, a pedestrian, another vehicle, a road structure, a signal, and a sign) around the vehicle 100. The control device 150 can recognize the objects around the vehicle 100 by using the recognition sensor. The object information includes a relative position and a relative speed of the object with respect to the vehicle 100.

The control device 150 executes vehicle traveling control of controlling traveling of the vehicle 100. The vehicle traveling control includes steering control, driving control, and braking control. The control device 150 executes the vehicle traveling control by controlling the traveling device 130 (steering device, driving device, and braking device).

The control device 150 may execute autonomous driving control based on the sensor detection information SEN. More specifically, the control device 150 generates a traveling plan of the vehicle 100 based on the sensor detection information SEN. Further, the control device 150 generates a target trajectory required for the vehicle 100 to travel according to the traveling plan based on the sensor detection information SEN. The target trajectory includes a target position and a target speed. Then, the control device 150 performs the vehicle traveling control such that the vehicle 100 follows the target trajectory.

During the remote operation of the vehicle 100, the control device 150 communicates with the remote operator terminal 200 via the communication device 110. The control device 150 transmits at least a part of the sensor detection information SEN to the remote operator terminal 200. The sensor detection information SEN transmitted to the remote operator terminal 200 includes at least the image IMG captured by the camera CAM. In addition, the control device 150 receives remote operation information OPE that will be described later, from the remote operator terminal 200. The remote operation information OPE is information reflecting a control input by the remote operator O. The control device 150 performs the vehicle traveling control according to the remote operation information OPE that is received.

### 1-2. Configuration Example of Remote Operator Terminal

The remote operator terminal 200 includes a communication device 210, a display device 220, an input device 230, and a control device 250.

The communication device 210 communicates with the vehicle 100 or the management device 300.

The display device 220 displays various types of information for the remote operator O who performs the remote operation. In other words, the display device 220 presents various types of information to the remote operator O by displaying the various types of information. Examples of the display device 220 include a display and a touch panel.

The input device 230 includes a member operated by the remote operator O in a case of remotely operating the vehicle 100. For example, the input device 230 includes a remote operation member. The remote operation member includes a steering wheel, an accelerator pedal, a brake pedal, a turn indicator, and the like.

The control device 250 is a computer that controls the remote operator terminal 200. The control device 250 includes one or more processors, and one or more storage devices. The processor executes various types of processing. Examples of the processor include a CPU, a GPU, an ASIC, and an FPGA. The processor can also be referred to as circuitry or processing circuitry. The storage device stores various types of information. Examples of the storage device include a volatile memory, a non-volatile memory, an HDD, and an SSD. A function of the control device 250 may be implemented by cooperation between the processor that executes a control program and the storage device. The control program is stored in the storage device. The control program may be recorded in a computer-readable recording medium.

During the remote operation of the vehicle 100, the control device 250 communicates with the vehicle 100 via the communication device 210. The control device 250 receives the sensor detection information SEN transmitted from the vehicle 100. The control device 250 presents necessary information in the received sensor detection information SEN to the remote operator O. For example, the control device 250 presents the image IMG to the remote operator O by displaying the image IMG on the display device 220. The remote operator O can recognize a state of the vehicle 100 and a situation around the vehicle 100 based on the information that is presented.

The remote operator O operates the input device 230. A control input of the input device 230 is detected by a sensor installed in the input device 230. The control device 250 generates the remote operation information OPE reflecting the control input (steering control input, accelerator control input, and brake control input) of the input device 230 by the remote operator O. Then, the control device 250 transmits the remote operation information OPE to the vehicle 100 via the communication device 210. In this way, the remote operation of the vehicle 100 is implemented.

### 2. Image Adjustment Processing for Plurality of Images

### 2-1. Outline

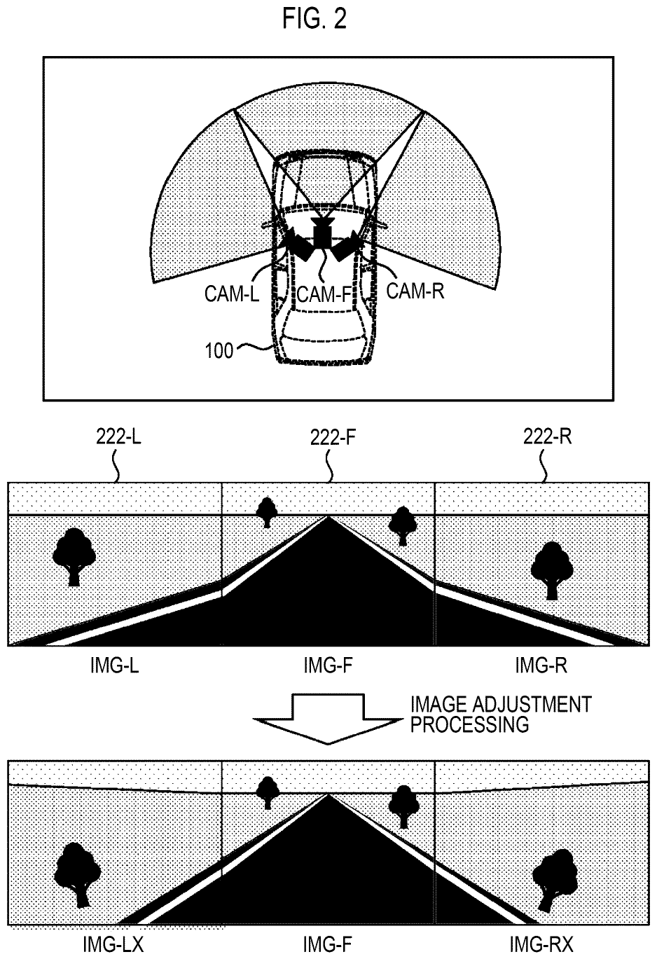

A case where a plurality of cameras CAM is mounted on the vehicle 100 as shown in FIG. 2 will be considered. An installation orientation of each of the cameras CAM in a vehicle coordinate system, that is, a line of sight direction of each of the cameras CAM is different from each other. For example, the cameras CAM include a front camera CAM-F for imaging the front side, a left camera CAM-L for imaging the left front side, and a right camera CAM-R for imaging the right front side. Field of views (imaging ranges) of the front camera CAM-F and the left camera CAM-L are adjacent to each other, and field of views (imaging ranges) of the front camera CAM-F and the right camera CAM-R are also adjacent to each other.

A front image IMG-F, a left image IMG-L, and a right image IMG-R are the images IMG captured by the front camera CAM-F, the left camera CAM-L, and the right camera CAM-R, respectively. The front image IMG-F, the left image IMG-L, and the right image IMG-R are collectively referred to as an “image set”. The remote operator terminal 200 acquires the image set from the vehicle 100 and displays the image set on the display device 220. By displaying the image set including the images IMG, a field of view of the remote operator O is expanded. As a result, safety of the remote operation is improved.

In the example shown in FIG. 2, the display device 220 includes display regions 222-F, 222-L, and 222-R. The front image IMG-F is displayed in the display region 222-F. The left image IMG-L is displayed in the display region 222-L. The right image IMG-R is displayed in the display region 222-R. The display regions 222-L, 222-F, and 222-R are arranged in a row in a horizontal direction. The display regions 222-L, 222-F, and 222-R may be connected in the horizontal direction. The display region 222-F is interposed between the display regions 222-L and 222-R. The display regions 222-L and 222-F are adjacent to each other. The display regions 222-R and 222-F are adjacent to each other. The display regions 222-L, 222-F, and 222-R have the same height. Since the front image IMG-F, the left image IMG-L, and the right image IMG-R are displayed adjacent to each other, the field of view of the remote operator O is further expanded. As a result, the safety of the remote operation is further improved.

The display region 222 can also be referred to as a “screen”. The display regions 222-L, 222-F, and 222-R may be connected to each other to form one large screen. The display region 222 (screen) may be a plane or a curved surface.

Imaging directions of the cameras CAM (CAM-F, CAM-L, CAM-R) are different from each other, that is, imaging directions of the images IMG (IMG-F, IMG-L, IMG-R) are different from each other. Therefore, in a case where the images IMG are simply arranged adjacent to each other, as shown in FIG. 2, there is a concern that a line such as a white line on a road surface appears unnaturally bent at an inter-image boundary. That is, there is a concern that discomfort is caused at the inter-image boundary. In order to make it easier for the remote operator O to perform the remote operation of the vehicle 100, it is desirable to suppress such discomfort.

Therefore, the remote operation system 1 according to the present embodiment adjusts (corrects) at least one of the images IMG included in the image set in order to suppress the discomfort at the inter-image boundary. The processing will be hereinafter referred to as “image adjustment processing”. In the example shown in FIG. 2, the left image IMG-L and the right image IMG-R are adjusted (corrected) such that bending of the white line at the inter-image boundary is reduced. The adjusted left image IMG-L and the adjusted right image IMG-R will be referred to as an adjusted left image IMG-LX and an adjusted right image IMG-RX, respectively. The front image IMG-F, the adjusted left image IMG-LX, and the adjusted right image IMG-RX are collectively referred to as an “adjusted image set”. That is, the remote operation system 1 according to the present embodiment acquires the adjusted image set by performing the image adjustment processing on the image set. The remote operation system 1 displays the adjusted image set on the display device 220 of the remote operator terminal 200. Through such image adjustment processing, discomfort felt by the remote operator O is suppressed. As a result, it is easier for the remote operator O to perform the remote operation of the vehicle 100.

### 2-2. Specific Example of Image Adjustment Processing

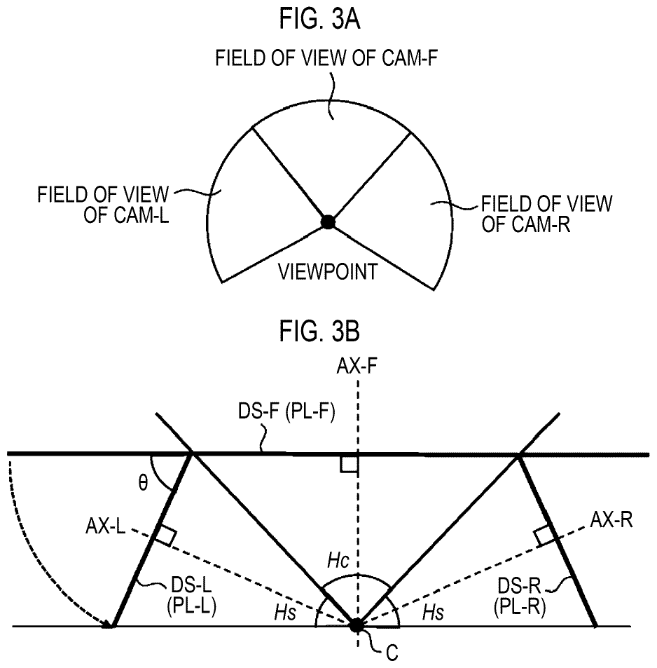

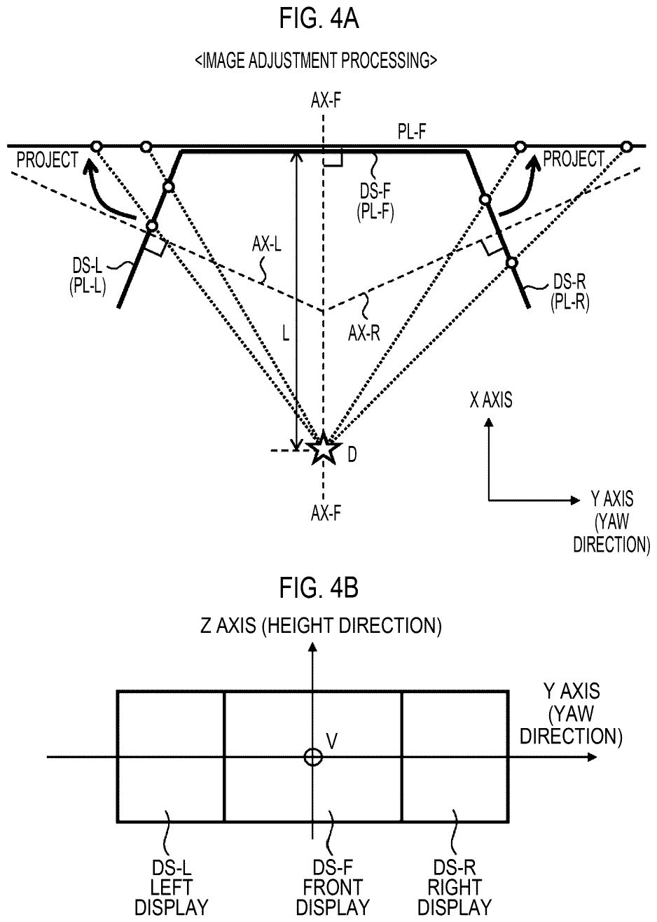

Hereinafter, a specific example of the image adjustment processing will be described with reference to FIGS. 3A, 3B, 4A, and 4B.

As shown in FIG. 3A, viewpoints of the cameras CAM (CAM-F, CAM-L, CAM-R) are assumed to coincide with each other. In addition, field of views of the cameras CAM (CAM-F, CAM-L, CAM-R) are assumed to be horizontally adjacent and continuous with each other. The field of views of the cameras CAM do not overlap. In other words, imaging ranges of the images IMG (IMG-F, IMG-L, IMG-R) are assumed to be horizontally adjacent and continuous with each other. The imaging ranges of the images IMG do not overlap. Even in a case where the actual configuration is slightly different from the assumptions, a certain effect can be obtained.

Next, a plurality of virtual displays DS (DS-F, DS-L, DS-R) used in the image adjustment processing will be described with reference to FIG. 3B. The front image IMG-F captured by the front camera CAM-F is displayed on a virtual front display DS-F. The left image IMG-L captured by the left camera CAM-L is displayed on a virtual left display DS-L. The right image IMG-R captured by the right camera CAM-R is displayed on a virtual right display DS-R.

More specifically, the virtual front display DS-F is disposed on a plane PL-F. The plane PL-F is orthogonal to an optical axis AX-F of the front camera CAM-F that has captured the front image IMG-F. The virtual left display DS-L is disposed on a plane PL-L. The plane PL-L is orthogonal to an optical axis AX-L of the left camera CAM-L that has captured the left image IMG-L. The virtual right display DS-R is disposed on a plane PL-R. The plane PL-R is orthogonal to an optical axis AX-R of the right camera CAM-R that has captured the right image IMG-R. Since the directions of the optical axes AX-F, AX-L, and AX-R are different from each other, the planes PL-F, PL-L, and PL-R are also different from each other.

The front display DS-F and the left display DS-L are disposed to be horizontally adjacent and continuous with each other. In addition, the front display DS-F and the right display DS-R are disposed to be horizontally adjacent and continuous with each other. A point C is a point corresponding to the viewpoint of the cameras CAM. The optical axes AX-F, AX-L, and AX-R intersect at the point C. In a case of being viewed from the point C, a horizontal field of view (HFOV) of the front display DS-F coincides with an HFOV of the front camera CAM-F. Here, the HFOV of the front display DS-F is an angle formed between a left end and a right end of the front display DS-F in a case of being viewed from the point C. Similarly, in a case of being viewed from the point C, the HFOV of the left display DS-L coincides with the HFOV of the left camera CAM-L, and the HFOV of the right display DS-R coincides with the HFOV of the right camera CAM-R. The optical axis AX-F of the front camera CAM-F passes through a center of the front display DS-F. The optical axis AX-L of the left camera CAM-L passes through a center of the left display DS-L. The optical axis AX-R of the right camera CAM-R passes through a center of the right display DS-R.

In FIG. 3B, “Hc” is the HFOV of the front camera CAM-F, that is, the HFOV of the front display DS-F. In addition, “Hs” is the HFOV of the left camera CAM-L, that is, the HFOV of the left display DS-L. In this case, an angle θ formed by the front display DS-F and the left display DS-L, that is, an angle θ formed by the plane PL-F and the plane PL-L, is represented by Expression (1).

θ=Hc/+Hs/s Expression (1):

The same applies to an angle formed by the front display DS-F and the right display DS-R, that is, an angle formed by the plane PL-F and the plane PL-R.

Next, FIGS. 4A and 4B will be described. A viewpoint D is a virtual viewpoint of the remote operator O assumed in the image adjustment processing. The viewpoint D does not necessarily have to coincide with an actual viewpoint of the remote operator O. A relative positional relationship between the viewpoint D and the virtual displays DS (DS-F, DS-L, DS-R) is designed (set) in advance by a designer in consideration of factors such as installation information of the cameras CAM and ease of the remote operation in a case of being viewed from the viewpoint D. The relative positional relationship between the viewpoint D and the virtual displays DS (DS-F, DS-L, DS-R) may be designed (determined) in advance for each vehicle model. For example, a coordinate system in which a position of the viewpoint D is set as an origin is considered. An X-axis is a forward direction, a Y-axis is a horizontal direction (yaw direction), and a Z-axis is a height direction. Typically, the viewpoint D is located on the optical axis AX-F of the front camera CAM-F. The disposition of the virtual displays DS (DS-F, DS-L, DS-R) in the coordinate system is designed (set) in advance by the designer in consideration of factors such as the installation information of the cameras CAM and the ease of the remote operation in a case of being viewed from the viewpoint D.

In addition, as shown in FIG. 4B, a height of the viewpoint D coincides with a height of a vanishing point in the front image IMG-F displayed on the front display DS-F. Further, the height of the viewpoint D coincides with a height of a vanishing point in the left image IMG-L displayed on the left display DS-L. Further, the height of the viewpoint D coincides with a height of a vanishing point in the right image IMG-R displayed on the right display DS-R. That is, in the image adjustment processing, the height of the viewpoint D is set to coincide with the height of the vanishing point in each of the images displayed on each of the virtual displays DS. As shown in FIG. 4B, heights of the virtual displays DS (DS-F, DS-L, DS-R) coincide with each other.

In the image adjustment processing, the front image IMG-F is displayed on the front display DS-F corresponding to the front camera CAM-F. That is, the front image IMG-F is disposed on the plane PL-F corresponding to the front camera CAM-F. In addition, the left image IMG-L is displayed on the left display DS-L corresponding to the left camera CAM-L. That is, the left image IMG-L is disposed on the plane PL-L corresponding to the left camera CAM-L. In addition, the right image IMG-R is displayed on the right display DS-R corresponding to the right camera CAM-R. That is, the right image IMG-R is disposed on the plane PL-R corresponding to the right camera CAM-R. In addition, the front image IMG-F (front display DS-F) on the plane PL-F and the left image IMG-L (left display DS-L) on the plane PL-L are arranged to be adjacent to each other. In addition, the front image IMG-F (front display DS-F) on the plane PL-F and the right image IMG-R (right display DS-R) on the plane PL-R are arranged to be adjacent to each other.

In the image adjustment processing, the images IMG (IMG-F, IMG-L, IMG-R) that are arranged are viewed from the common viewpoint D, and the images IMG (IMG-F, IMG-L, IMG-R) are projected onto a “common plane”. The adjusted images IMG through the projection processing are adjusted images. That is, the image adjustment processing acquires the adjusted image set by projecting the image set onto the common plane as viewed from the common viewpoint D.

In the example shown in FIG. 4A, the “common plane” is the plane PL-F (first plane) on which the front image IMG-F (first image) is disposed. In the image adjustment processing, the adjusted left image IMG-LX is generated by projecting the left image IMG-L (second image) on the plane PL-L (second plane) onto the plane PL-F (first plane) as viewed from the viewpoint D. In this case, the angle θ between the plane PL-F (first plane) and the plane PL-L (second plane) is given by Expression (1). In the image adjustment processing, the left image IMG-L (second image) on the plane PL-L (second plane) is projected onto the plane PL-F (first plane) based on the angle θ given by Expression (1). Image projection transformation is a well-known technique. The same applies to the right image IMG-R. In the image adjustment processing, the adjusted right image IMG-RX is generated by projecting the right image IMG-R (second image) on the plane PL-R (second plane) onto the plane PL-F (first plane) as viewed from the viewpoint D. The adjusted image set includes the front image IMG-F, the adjusted left image IMG-LX, and the adjusted right image IMG-RX.

The common plane is not limited to the plane PL-F. The common plane is optional. The common plane may be dynamically changed according to a gaze direction of the remote operator O. The gaze direction of the remote operator O is estimated from, for example, steering information of the remote operator O or a traveling direction of the vehicle 100. For example, in a case where a steering direction of the remote operator O is to the left and a steering angle is equal to or greater than a value that is predetermined, it is estimated that the remote operator O is gazing toward the left, and the common plane may be set to the left plane PL-L. More generally, a plane PL corresponding to the gaze direction of the remote operator O may be set as the common plane.

### 2-3. Effects

As described above, according to the present embodiment, the image adjustment processing is executed on the image set including the images IMG. In the image adjustment processing, the first image is disposed on the first plane and the second image is disposed on the second plane. Further, in the image adjustment processing, the adjusted image set is acquired by viewing the first image and the second image that are disposed, from the common viewpoint D, and by projecting the first image and the second image onto the common plane. Then, the adjusted image set is displayed on the remote operator terminal 200. Through such image adjustment processing, for example, bending of a line such as a white line at the inter-image boundary is suppressed (see FIG. 2). That is, the discomfort felt by the remote operator O with respect to the images IMG is reduced. As a result, it is easier for the remote operator O to perform the remote operation of the vehicle 100.

In the above description, several assumptions have been made, but even in a case where the actual configuration is slightly different from the assumptions, a certain effect can be obtained.

### 3. Functional Configuration Example

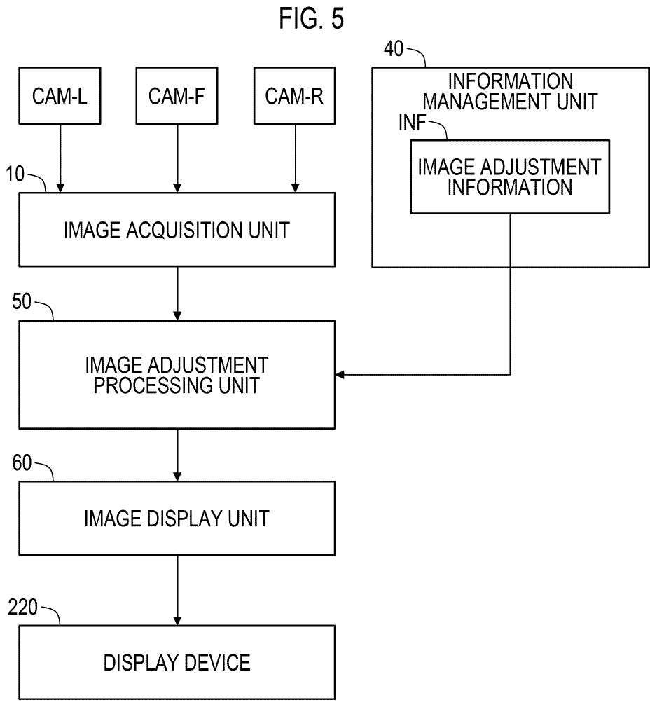

FIG. 5 shows a functional configuration example related to the image adjustment processing. The remote operation system 1 includes an image acquisition unit 10, an information management unit 40, an image adjustment processing unit 50, and an image display unit 60. The functional blocks are included in the vehicle 100 or the remote operator terminal 200.

The image acquisition unit 10 acquires the images IMG (IMG-F, IMG-L, IMG-R) captured at the same time by each of the cameras CAM (CAM-F, CAM-L, CAM-R) mounted on the vehicle 100. The image set includes the images IMG (IMG-F, IMG-L, IMG-R). The image acquisition unit 10 is included in the vehicle 100.

The information management unit 40 manages and holds image adjustment information INF. The image adjustment information INF is information necessary for the image adjustment processing. For example, the image adjustment information INF includes information on field-of-view angles (horizontal field-of-view angle and vertical field-of-view angle) of each of the cameras CAM mounted on the vehicle 100. The field-of-view angle of each of the cameras CAM is determined by a hardware configuration and performance of each of the cameras CAM. In addition, the image adjustment information INF includes information on a relative positional relationship between the viewpoint D and the virtual displays DS (DS-F, DS-L, DS-R). As described above, the relative positional relationship is designed (set) in advance by the designer in consideration of factors the installation information (installation position and orientation) of the cameras CAM and the ease of the remote operation in a case of being viewed from the viewpoint D. The relative positional relationship may be set in advance for each vehicle model. Further, the image adjustment information INF includes information on coordinates (particularly, height) of the vanishing point on the image in each image IMG. The coordinates of the vanishing point are determined depending on the installation information (installation position and orientation) of each of the cameras CAM. Further, the image adjustment information may include information on a resolution of each of the cameras CAM.

The information management unit 40 is included in, for example, the vehicle 100. In a case where the image adjustment information INF is set for each vehicle model, the information management unit 40 is preferably included in the vehicle 100. However, the information management unit 40 need not be included in the vehicle 100. The information management unit 40 may be included in the remote operator terminal 200 or the management device 300.

The image adjustment processing unit 50 acquires the image set from the image acquisition unit 10. In addition, the image adjustment processing unit 50 acquires the image adjustment information INF from the information management unit 40. The image adjustment processing unit 50 performs the image adjustment processing on the image set based on the image adjustment information INF to acquire the adjusted image set. The image adjustment processing is as described in Section 2 above. The image adjustment processing unit 50 may be included in the vehicle 100 or may be included in the remote operator terminal 200.

The image display unit 60 is included in the remote operator terminal 200. The image display unit 60 acquires the adjusted image set from the image adjustment processing unit 50. The image display unit 60 displays the adjusted image set on the display device 220 of the remote operator terminal 200.

### 4. Modification

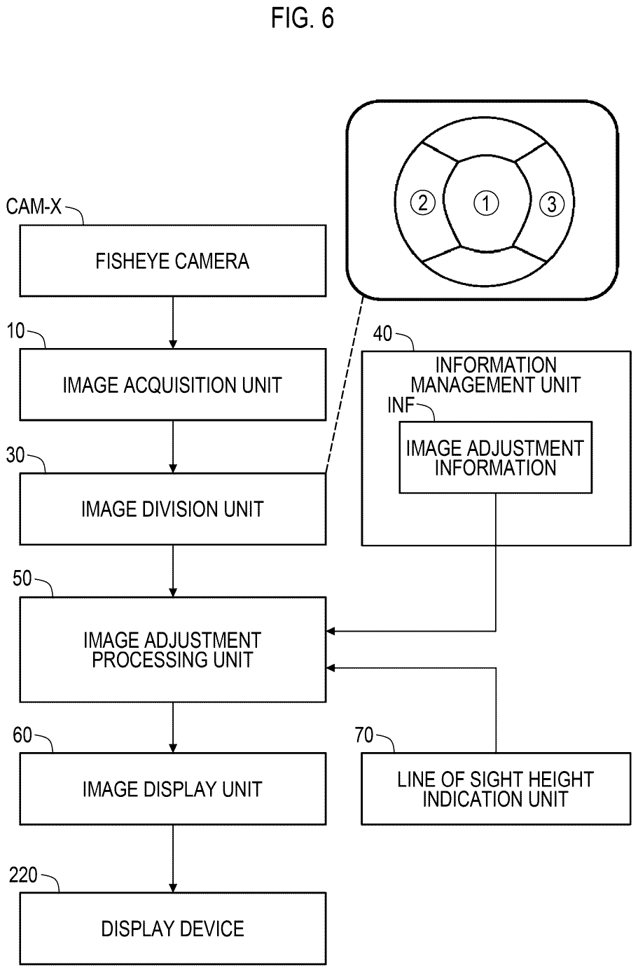

FIG. 6 is a block diagram showing a modification. The vehicle 100 equipped with a fisheye camera CAM-X. The image acquisition unit 10 acquires an image IMG-X captured by the fisheye camera CAM-X.

The remote operation system 1 includes an image division unit 30. The image division unit 30 crops the images IMG from one image IMG-X captured by the fisheye camera CAM-X. In this case, the images IMG are cropped such that the imaging ranges of the images IMG are adjacent to and continuous with each other. For example, a field-of-view angle of the fisheye camera CAM-X may be 180 deg. In this case, a partial image corresponding to 90 deg ahead is cropped as the front image IMG-F, a partial image corresponding to 45 deg on the left side is cropped as the left image IMG-L, and a partial image corresponding to 45 deg on the right side is cropped as the right image IMG-R. The image set includes the images IMG (IMG-F, IMG-L, IMG-R). A method of cropping a partial image from one image captured by a fisheye camera is a well-known technique.

The image adjustment information INF managed by the information management unit 40 includes, in addition to the information, information on optical axis center coordinates, a projection method, and the like related to the fisheye camera CAM-X.

The image adjustment processing unit 50 acquires the image set from the image acquisition unit 10. In addition, the image adjustment processing unit 50 acquires the image adjustment information INF from the information management unit 40. The image adjustment processing unit 50 performs the image adjustment processing on the image set based on the image adjustment information INF to acquire the adjusted image set. The image adjustment processing is as described in Section 2 above. The image adjustment processing unit 50 may be included in the vehicle 100 or may be included in the remote operator terminal 200.

In a case where the fisheye camera CAM-X is used, the line of sight height can also be changed in response to an instruction from the remote operator O. Therefore, the remote operation system 1 may further include a line of sight height indication unit 70. The remote operator O designates the line of sight height using the input device 230. The line of sight height indication unit 70 acquires information on the line of sight height designated by the remote operator O, and passes the information on the line of sight height to the image adjustment processing unit 50.

The image adjustment processing unit 50 recalculates the coordinates (particularly, the height) of the vanishing point on the image IMG according to the line of sight height designated by the remote operator O. The following methods can be considered to obtain the coordinates of the vanishing point on the image IMG. For example, the image adjustment processing unit 50 extracts feature points in the image IMG before and after the line of sight is changed, and sets a displacement of the feature points as a displacement of the vanishing point coordinates. As another example, the image adjustment processing unit 50 may detect a plurality of white lines on the road using a lane detection technique, and may recognize an intersection point of the white lines that are detected, as the vanishing point. The image adjustment processing unit 50 performs the image adjustment processing based on the coordinates of the vanishing point after the recalculation.

As described above, the image adjustment processing according to the present embodiment can also be applied to the images IMG obtained by using the fisheye camera CAM-X. The same effects as described above can be obtained by the present modification.

What is claimed is:

1. A remote operation system for a remote operation of a moving object by a remote operator, the remote operation system comprising one or more processors, wherein:
the one or more processors are configured to
acquire an image set including a plurality of images obtained by using one or more cameras mounted on the moving object,
execute image adjustment processing of acquiring an adjusted image set by adjusting at least one of the images, and
display the adjusted image set on a remote operator terminal used by the remote operator;
the images include a first image and a second image, in which
a first plane is a plane orthogonal to an optical axis of a camera corresponding to the first image, and
a second plane is a plane orthogonal to an optical axis of a camera corresponding to the second image; and
the image adjustment processing includes
disposing the first image on the first plane and disposing the second image on the second plane, and
acquiring the adjusted image set by viewing, from a common viewpoint, the first image and the second image that are disposed, and by projecting the first image and the second image onto a common plane.

2. The remote operation system according to claim 1, wherein:
a relative positional relationship between the common viewpoint, and the first plane, and the second plane is predetermined, and
the one or more processors are configured to further acquire image adjustment information indicating the relative positional relationship, and to execute the image adjustment processing based on the image adjustment information.

3. The remote operation system according to claim 1, wherein the images are respectively captured by a plurality of cameras having adjacent fields of view, or are obtained by dividing an image captured by a fisheye camera.

4. The remote operation system according to claim 1, wherein:
an imaging range of the first image and an imaging range of the second image are adjacent to each other;
the common plane is the first plane on which the first image is disposed; and
the image adjustment processing includes
disposing the first image on the first plane and the second image on the second plane to be adjacent to each other,
generating a second adjusted image by projecting the second image on the second plane onto the first plane, and
acquiring the adjusted image set including the first image and the second adjusted image.

5. The remote operation system according to claim 4, wherein the image adjustment processing further includes generating the second adjusted image by projecting the second image on the second plane onto the first plane based on an angle between the first plane and the second plane.
